(19) United States
(12) Patent Application Publication
(10) Pub. No.: US 2005/0106455 A1
(43) Pub. Date: May 19, 2005

(54) Battery having metal terminal fixed to battery case

(75) Inventors: Hiroaki Yoshida, Kyoto-shi (JP); Naozumi Miyanaga, Kyoto-shi (JP)

Correspondence Address: SUGHRUE MION, PLLC, 2100 PENNSYLVANIA AVENUE, N.W., SUITE 800, WASHINGTON, DC, 20037, US

(73) Assignee: JAPAN STORAGE BATTERY CO., LTD.

(21) Appl. No.: 10/956,119

(22) Filed: Oct. 4, 2004

(30) Foreign Application Priority Data
Oct. 2, 2003 (JP) P. 2003-344981

(51) Int. Cl. H01M 2/30

(52) U.S. Cl. 429/178

(57) ABSTRACT

A battery provided with the following elements: a battery case; a metal terminal fixed to the battery case; a hole created in the metal terminal, having an opening part outside of the battery case; a member fitted into the hole, composed of a material whose mechanical strength is higher than the metal terminal, wherein the member comprises a projecting portion which protrudes from the hole; and a male screw part created in the projecting portion.

### FIELD OF THE INVENTION

The present invention relates to batteries which have a metal terminal fixed to the battery case.

### BACKGROUND OF THE INVENTION

As electronic devices are rapidly reduced in size and weight, the demand is growing for batteries as a power source of electronic devices, that secondary batteries which are small and lightweight, have high energy density and further are repeatedly chargeable and dischargeable should be developed. Also, owing to environmental issues such as air pollution and the increase in carbon dioxide, an early practical application of an electric vehicle is anticipated. Therefore, there is a demand for the development of excellent secondary batteries which have characteristics such as high efficiency, high power, high energy density and lightweight.

As a secondary battery which satisfies these demands, the secondary battery which employs nonaqueous electrolyte has been put to practical use. An example of this nonaqueous electrolyte secondary battery is the lithium ion battery which employs lithium cobalt oxide, lithium nickel oxide and spinel lithium manganese oxide or the like as a positive electrode active material, and employs materials such as a carbon material which can absorb and release lithium at the negative electrode, which has been put to practical use. In the lithium ion battery, excellent cycle life property and excellent safety are achieved.

For an electrolyte of the nonaqueous electrolyte secondary battery, an electrolytic solution is generally employed in which support salt such as LiPF₆ or LiBF₄ is dissolved in mixed solvents consisting of a high dielectric constant solvent such as ethylene carbonate or propylene carbonate, and a low viscosity solvent such as dimethyl carbonate or diethyl carbonate.

The shape of the nonaqueous electrolyte secondary battery is not limited to a specific shape, and various shapes of batteries have been produced including prismatic, cylindrical, elliptic cylindrical, coin-type and button-type batteries employing a metal case, as well as a sheet-type battery or the like employing a laminate sheet case of metal and resin.

Generally, in the case of the nonaqueous electrolyte secondary battery which is relatively small in capacity equal to or less than 5 Ah, the amount of electric current which passes through a terminal is small at about a few A. Therefore, an outer lead plate which leads from a battery to electronic equipment is directly fixed to the terminal of the battery by resistance welding or ultrasonic welding and the like. On the other hand, in the case of the nonaqueous electrolyte secondary battery which is large in capacity more than 5 Ah or the nonaqueous electrolyte secondary battery in which the amount of electric current passing through the terminal is larger than 10A, an outer lead plate and an outer lead wire need to be fixed to the battery terminal by a bolt so that the electric current capacity of the terminal and the outer lead plate can be increased.

The terminal structure of a large-sized elliptic cylindrical nonaqueous electrolyte secondary battery is disclosed in 2003-223885A of the Japanese published patent application. FIG. 9 is an assembling perspective view of a conventional elliptic cylindrical nonaqueous electrolyte secondary battery, FIG. 10 is a partially enlarged longitudinal cross-sectional view of a positive electrode terminal, and FIG. 11 is a partially enlarged longitudinal cross-sectional view of a negative electrode terminal. In FIGS. 9 to 11, reference numeral 1 denotes a power generating element, 2 denotes a metal container, 3 denotes a lid plate, 4 denotes a positive electrode terminal, 5 denotes a negative electrode terminal, 6 denotes an insulation cylinder, 7 denotes a terminal support plate, 8 and 9 denote aluminum brazing, 10 denotes copper alloy based metal brazing, and 11 denotes female screw processing.

In this nonaqueous electrolyte secondary battery, the elliptic cylindrical winding-type power generating element 1 is accommodated in the elliptic cylindrical container-like metal container 2. The oval lid plate 3 is fitted on the upper end opening part of this metal container 2. The engagement part thereof is sealed and fixed by welding. The respective terminal support plates 7 are fixed through the ceramics insulation cylinders 6 to the positive electrode terminal 4 which is connected to the positive electrode of the power generating element 1 and to the negative electrode terminal 5 which is connected to the negative electrode thereof.

That is, as shown in FIG. 10, the positive electrode terminal 4 is inserted into the inner cylinder of the tube-like insulation cylinder 6. The engagement part thereof is sealed and fixed by brazing with the aluminum brazing 8. The insulation cylinder 6 is inserted into the open hole of the terminal support plate 7. The engagement part thereof is sealed and fixed by brazing with the aluminum brazing 9. Here, for the positive electrode terminal 4, aluminum alloy is employed which does not dissolve in a nonaqueous electrolyte solution at a positive electrode potential. The potential of the brazing material between the positive electrode terminal 4 and the insulation cylinder 6 becomes equal to the potential of the positive electrode. Therefore, the aluminum brazing 8 is employed also for the brazing material. The terminal support plate 7 is insulated from the positive and negative electrodes. Therefore, materials such as aluminum alloy, stainless steel or nickel-plated iron sheet are employed for the terminal support plate 7. When aluminum alloy is employed for the terminal support plate 7, the aluminum brazing 9 is employed also for the brazing material between the terminal support plate 7 and the insulation cylinder 6, as shown in FIG. 10.

The negative electrode terminal 5 shown in FIG. 11 is inserted, as is the positive electrode terminal, into the inner cylinder of the tube-like insulation cylinder 6. The engagement part thereof is sealed and fixed by brazing with the copper alloy based metal brazing 10 such as gold-copper brazing. The insulation cylinder 6 is inserted into the open hole of the terminal support plate 7. The engagement part thereof is sealed and fixed by brazing with the aluminum brazing 8. Here, for the negative electrode terminal 5, copper and copper alloy are employed, which are not prone to electrochemical corrosion at a negative electrode potential. Since the potential of the brazing material between the negative electrode terminal and the insulation cylinder 6 also becomes equal to the potential of the negative electrode, the copper alloy based metal brazing 10 is employed also for that brazing material. For the brazing material of the engagement part between the terminal support plate 7 and the insulation cylinder 6, the same aluminum brazing 9 is employed as in the case of the positive electrode terminal.

As shown in FIG. 9, the positive electrode terminal 4 and the negative electrode terminal 5 are connected to the power generating element. The terminal support plates 7 and 7, whose terminals are sealed and fixed through the insulation cylinders 6 and 6, are then sealed and fixed by being fitted into the open holes created at both ends of the lid plate 3 and welding. The power generating element 1 thus fixed to the lower part of the lid plate 3 is inserted inside the metal container 2. The inside of the battery case is closed by fitting the lid plate 3 into the upper end opening part of the metal container 2 and welding.

As shown in FIG. 10 and FIG. 11, the female screw processing 11 is applied to the positive electrode terminal 4 and the negative electrode terminal 5 respectively. An outer lead plate is connected and bolted to either the positive electrode terminal 4 or the negative electrode terminal 5 by a stainless steel bolt. For example, a hole is created in the outer lead plate, the male screw part of the bolt is inserted into the hole and is then inserted into the female screw processing 11. Since the outer lead plate is pressed against the upper end of either the positive electrode terminal 4 or negative electrode terminal 5 in the result, the electrical connection between the outer lead plate and the terminal is ensured.

In batteries whose capacities are equal to or less than 5 Ah, the amount of electric current which passes through the terminal is generally small at about a few A. Therefore, the bolting described above is not performed. In such batteries, the outer lead plate is directly fixed to the terminal by resistance welding, ultrasonic welding or the like. On the other hand, in the case of the batteries whose rated capacities are more than 5 Ah or the batteries in which the amount of electric current which passes through a terminal is larger than 10A, bolting is required to increase the electric current capacity of the terminal.

However, the mechanical strength of the female screw part 11 of aluminum or aluminum alloy used for the positive electrode terminal 4 is extremely lower than the mechanical strength of the stainless steel bolt used for bolting the outer lead plate. Similarly, the mechanical strength of the female screw part 11 of copper or copper alloy used for the negative electrode terminal 5 is lower than the mechanical strength of the bolt. Consequently, in the nonaqueous electrolyte secondary battery which employs a metal terminal having a female screw part, when mechanical stress is applied on the terminal during use or assembly of a combination battery, the female screw parts of the positive electrode terminal and negative electrode terminal are easily destroyed. Consequently, since the contact pressure between the outer lead plate and the terminal or bolt decreases easily, there is a problem in that the contact resistance therebetween increases. Particularly, when the outer lead plate is repeatedly attached to and removed from the terminal during the use of a battery, there is a problem in that the screw thread of the female screw part 11 created in the terminal is easily smashed.

In order to solve the above problems, it is suggested in 2000-138055A of the Japanese published patent application, that a metal helical insert whose mechanical strength is higher than aluminum should be mounted in the screw part for connection of the positive electrode terminal composed of aluminum. In this patent document, it is similarly suggested that a helical insert should also be mounted in the negative electrode terminal which employs steel or steel alloy. The helical insert described in this patent document is composed of iron steel, stainless steel, copper alloy, titanium alloy, nickel alloy, aluminum alloy or the like, and is formed by spirally and tightly winding metal material having elasticity. The outer peripheral surface of this coil becomes male screw-like and the inner peripheral surface thereof becomes female screw-like. This helical insert is mounted in the female screw part created in the terminal using an insertion tool. Therefore, even when a bolt is repeatedly attached and removed, destruction of the screw thread of the female screw part created in the terminal is suppressed. Furthermore, it is suggested in the same patent document that a sleeve composed of a metal material whose mechanical strength is higher than aluminum should be mounted in the female screw part or male screw part created in the aluminum battery terminal. The sleeve described in this patent document means a cylinder which is composed of iron steel, stainless steel, copper alloy, titanium alloy, nickel alloy or the like (regardless of whether the sleeve has a lid for shutting one end of the cylinder). A male screw is formed on the outer peripheral surface of the sleeve and a female screw is formed on the inner peripheral surface thereof. This sleeve is mounted in the female screw part or male screw part created in the terminal using an insertion tool. Therefore, even when a bolt is repeatedly attached and removed, destruction of the screw thread of the screw part created in the terminal is suppressed. However, when the helical insert or sleeve is mounted in the female screw of the terminal, the diameter of the terminal must be larger by the size of the helical insert or sleeve and consequently, there is a problem in that the weight of the terminal becomes heavier with the result that the battery becomes heavier and the weight energy density of the battery is decreased. There is also a problem in that it is impossible to design a compact battery since the terminal becomes larger. There is a problem in that when the sleeve is mounted in the male screw of the terminal, the contact area between the terminal and the outer lead plate becomes smaller by the size of the sleeve and consequently, there is a problem in that it is impossible to decrease the electric resistance value between the terminal and the outer lead plate.

Furthermore, the same patent document suggests as conventional art, a metal connector in which the female screw part is formed in the upper portion and the male screw part is formed in the lower portion. This metal connector is composed of a metal having high strength such as iron steel or stainless steel. The male screw part of the metal connector is inserted into the female screw part composed of aluminum created in the positive electrode terminal. Therefore, the connection of the outer lead plate to between the bolt and the metal connector becomes possible by inserting the bolt into the female screw part formed in the upper portion of the metal connector. Therefore, destruction of the screw thread created at the terminal is suppressed. In this method, however, since the large metal connector is employed, the weight of the battery becomes heavier by the weight of the metal connector as well as the volume of the battery becomes larger. Therefore, there is a problem in that a battery having high energy density cannot be obtained.

### SUMMARY OF THE INVENTION

The present invention is invented to solve the above problems.

A first aspect of the present invention is a battery which is provided with the following elements: a battery case; a metal terminal fixed to the battery case; a hole created in the metal terminal, having an opening part outside of the battery case; a member fitted into the hole, composed of a material whose mechanical strength is higher than that of the metal terminal, wherein the member comprises a projecting portion which protrudes from the hole; and a male screw part created in the projecting portion.

According to the present invention, even when mechanical stress is applied on the terminal during use or assembly of the battery, destruction of the terminal part can be reliably prevented. Furthermore, the electric continuity between the metal terminal and the outer lead can be sufficiently obtained without increasing the sizes of the terminal and part around the terminal. As a result, a battery having high energy density can be obtained.

### BRIEF DESCRIPTION OF THE DRAWINGS

FIG. 1, which shows a first embodiment of the present invention, is a partially enlarged longitudinal cross-sectional view showing the structure of a positive electrode terminal of a nonaqueous electrolyte secondary battery;

FIG. 2, which shows the first embodiment of the present invention, is a partially enlarged longitudinal cross-sectional view showing the structure of a negative electrode terminal of the nonaqueous electrolyte secondary battery;

FIG. 3, which shows the first embodiment of the present invention, is a partially enlarged longitudinal cross-sectional view showing terminal structure of the nonaqueous electrolyte secondary battery in the case in which a rod is pressed into the terminal;

FIG. 4, which shows a second embodiment of the present invention, is a partially enlarged longitudinal cross-sectional view showing the structure of the positive electrode terminal whose surface is nickel-plated;

FIG. 5, which shows the second embodiment of the present invention, is a partially enlarged longitudinal cross-sectional view showing the structure of the negative electrode terminal whose surface is nickel-plated;

FIG. 6 is a partially enlarged perspective view showing the case in which polarity is displayed in characters in the upper end portion of a bolt embedded into the terminal;

FIG. 7 is a partially enlarged perspective view showing the case in which polarity is displayed by a recess portion in the upper end portion of the bolt embedded into the terminal;

FIG. 8 is a partially enlarged perspective view showing the case in which polarity is displayed by the recess portion and a projecting portion in the upper end portion of the bolt embedded into the terminal;

FIG. 9 is an assembling perspective view showing the structure of a nonaqueous electrolyte secondary battery of a conventional example;

FIG. 10 is a partially enlarged longitudinal cross-sectional view of a positive electrode terminal of the nonaqueous electrolyte secondary battery of the conventional example; and

FIG. 11 is a partially enlarged longitudinal cross-sectional view of a negative electrode terminal of the nonaqueous electrolyte secondary battery of the conventional example.

### DETAILED DESCRIPTION OF THE INVENTION

A first aspect of the present invention is a battery which is provided with the following elements; a battery case; a metal terminal fixed to the battery case; a hole created in the metal terminal, having an opening part outside of the battery case; a member fitted into the hole, composed of a material whose mechanical strength is higher than the metal terminal, wherein the member comprises a projecting portion which protrudes from the hole; and a male screw part created in the projecting portion.

According to the present invention, in the battery, the metal terminal is preferably a negative electrode terminal composed of copper or copper alloy, and the member fitted into the hole created in the metal terminal is preferably composed of any one material chosen from iron, alloy containing chrome and iron, nickel or nickel alloy.

This allows the material of the metal terminal to become a metal which is not prone to electrochemical corrosion at a negative electrode potential (particularly at a negative electrode potential of a lithium ion battery). Therefore, even when the metal terminal makes contact with electrolyte solution in the battery, corrosion is difficult to progress. As a result, production of a long-lived nonaqueous electrolyte battery becomes possible. Furthermore, since the metal terminal is provided with a member composed of any one material chosen from iron, alloy containing chrome and iron, nickel or nickel alloy whose mechanical strengths are high, even when mechanical stress is applied on the terminal during assembly process or use of the battery, destruction of the terminal part is reliably prevented.

Furthermore, according to the present invention, in the battery, the metal terminal is preferably a positive electrode terminal composed of aluminum or aluminum alloy, and the member fitted into the hole created in the metal terminal is preferably composed of any one material chosen from iron, alloy containing chrome and iron, nickel, and nickel alloy.

This allows the material of the metal terminal to become a metal which is not prone to electrochemical corrosion at a positive electrode potential (particularly at a positive electrode potential of a lithium ion battery). Therefore, even when the metal terminal makes contact with electrolyte solution in the battery, corrosion is difficult to progress. As a result, production of a long-lived nonaqueous electrolyte battery becomes possible. Furthermore, since this metal terminal is provided with a member composed of any one material chosen from iron, alloy containing chrome and iron, nickel, and nickel alloy whose mechanical strengths are high, even when mechanical stress is applied on the terminal during assembly process or use of the battery, destruction of the terminal part is reliably prevented.

Also, in the abovementioned battery, the surface of the metal terminal of copper, copper alloy, aluminum, aluminum alloy or the like is preferably nickel-plated, gold-plated or silver-plated. Since the metal terminal is different from the member fitted into the hole created therein in metal material, potential difference occurs therebetween. The abovementioned plating reliably prevents occurrence of corrosion caused by the potential difference.

### DETAILED DESCRIPTION OF THE PREFERRED EMBODIMENTS

Hereinafter, embodiments of the present invention will be described with reference to the accompanying drawings. This embodiment will describe, in a lithium ion battery which is one type of nonaqueous electrolyte secondary batteries, the structure of ceramic-hermetic sealing of the same positive electrode terminal and negative electrode terminal as in a conventional example. A battery case of a nonaqueous electrolyte secondary battery, similarly to the battery case shown in FIG. 9, is made up of a elliptic cylindrical container-like metal container 2; a lid plate 3 fitted into the upper end opening part of the metal container 2, sealed and fixed by welding; and terminal support plates 7 and 7 fitted into the open hole of the lid plate 3, sealed and fixed by welding. A positive electrode terminal 4 is sealed and fixed to one terminal support plate 7 through an insulation cylinder 6, and a negative electrode terminal 5 is sealed and fixed to the other terminal support plate 7 through the insulation cylinder 6.

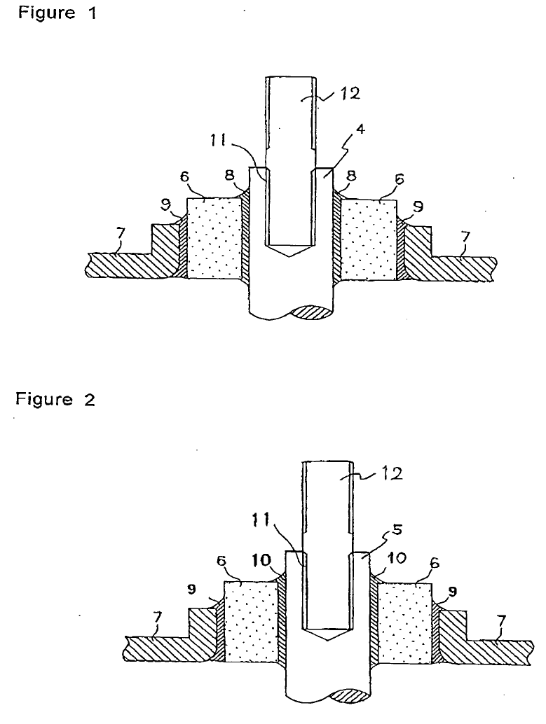

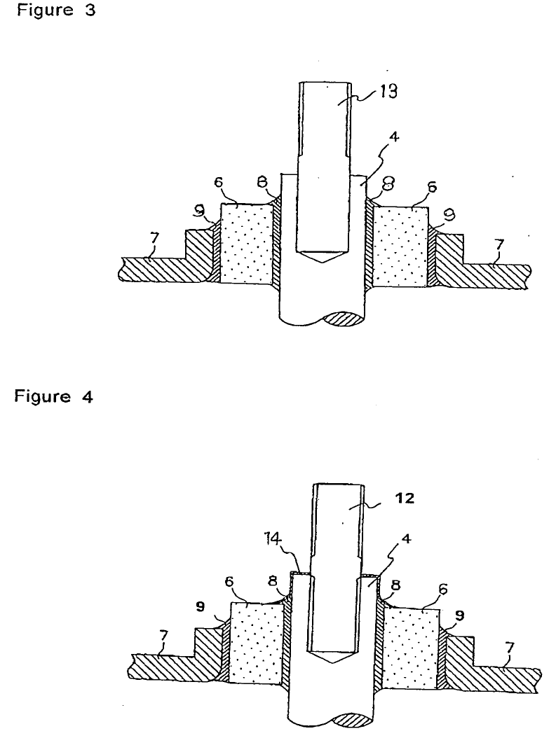

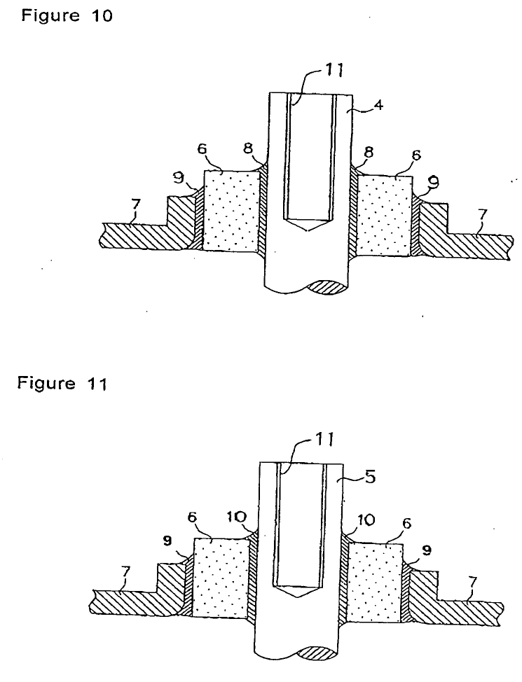

FIGS. 1 to 3 show a first embodiment of the present invention, each of which is a partially enlarged longitudinal cross-sectional view showing the structure of the terminal of the nonaqueous electrolyte secondary battery. FIG. 1 is a partially enlarged longitudinal cross-sectional view showing the structure of the positive electrode terminal in which a female screw is created in the positive electrode terminal, a bolt having a male screw is employed as a member provided in the positive electrode terminal, and the bolt is fitted into the female screw of the positive electrode terminal. FIG. 2 is a partially enlarged longitudinal cross-sectional view showing the structure of the negative electrode terminal in which a female screw is created in the negative electrode terminal, a bolt having a male screw is employed as a member provided in the negative electrode terminal, and the bolt is fitted into the female screw of the negative electrode terminal. FIG. 3 is a partially enlarged longitudinal cross-sectional view showing the structure of the positive electrode terminal in which a hole is created in the positive electrode terminal, a metal rod is employed as a member provided in the positive electrode terminal, and the metal rod is pressed into the hole of the positive electrode terminal. It is to be noted that reference numerals 4 to 11 in FIGS. 1 to 3 denote the identical structural members to the structural members of the conventional example shown in FIGS. 9 to 11. Reference numeral 12 denotes a bolt and 13 denotes a rod. In any one of FIGS. 1 to 3, the upper sides of the terminal support plates 7 and 7 correspond to the outside of the battery case, and the bottom sides of the terminal support plates 7 and 7 correspond to the inside of the battery case.

The positive electrode terminal 4 shown in FIG. 1 is inserted into the inner cylinder of the ceramics insulation cylinder 6 from the lower part. This positive electrode terminal 4 is a cylindrical pin composed of aluminum or aluminum alloy which does not dissolve in a nonaqueous electrolyte solution at a positive electrode potential (particularly at a positive electrode potential of a lithium ion battery). A hole in which the female screw 11 is formed is created at the center of the upper portion of the positive electrode terminal 4. The bolt 12 made of SUS304 stainless steel is fitted into and fixed to the female screw 11. This bolt 12 corresponds to the “member composed of a material whose mechanical strength is higher than the metal terminal” in the present invention. Regarding the bolt 12, the portion thereof which protrudes outside the hole created in the positive electrode terminal 4 corresponds to the “projecting portion” in the present invention. A male screw part is created in this projecting portion. The lower end portion of the positive electrode terminal 4, as shown in FIG. 9, is welded to the current collector connected to the positive electrode of the power generating element 1. The material of the ceramics insulation cylinder 6 is 99% alumina which is not prone to corrosion by nonaqueous electrolyte solution characteristically. The insulation cylinder 6 and the positive electrode terminal 4 are brazed together with aluminum brazing 8, and a metallized layer is adhered to the surface to be brazed with the aluminum brazing 8. Also, the engagement part between the terminal support plate 7 and the insulation cylinder 6 is brazed with aluminum brazing 9 similar to the aluminum brazing used in the case of the positive electrode terminal 4.

The negative electrode terminal 5 shown in FIG. 2 is also inserted into the inner cylinder of the ceramics insulation cylinder 6 from the lower part. This negative electrode terminal 5 is a cylindrical pin composed of copper or copper alloy which is not prone to electrochemical corrosion at a negative electrode potential (particularly at a negative electrode potential of a lithium ion battery). A hole in which the female screw 11 is formed is created at the center of the upper portion of the negative electrode terminal 5. The bolt 12 made of SUS304 stainless steel is fitted into and fixed to the female screw 11. This bolt 12 corresponds to the “member composed of a material whose mechanical strength is higher than the metal terminal” in the present invention. Regarding the bolt 12, the portion thereof which protrudes outside the hole created in the negative electrode terminal 5 corresponds to the “projecting portion” in the present invention. A male screw part is created in this projecting portion. The lower end portion of the negative electrode terminal 5, as shown in FIG. 9, is welded to the current collector connected to the negative electrode of the power generating element 1. The material of the ceramics insulation cylinder 6 is 99% alumina which is not prone to corrosion by nonaqueous electrolyte solution characteristically. The insulation cylinder 6 and the negative electrode terminal 5 are brazed together with copper alloy based metal brazing 10, and a metallized layer is adhered to the surface to be brazed with the copper alloy based metal brazing 10. Also, the engagement part between the terminal support plate 7 and the insulation cylinder 6 is brazed with the aluminum brazing 9.

As shown in FIG. 3, a rod 13 may also be pressed into the hole created in a metal terminal. Not a female screw but a cylindrical hole is created in the positive electrode terminal 4. The stud section of the rod 13 is a cylinder which is larger than this hole in diameter. When the rod 13 is inserted into the hole created in the metal terminal by applying pressure, becoming in a close-fit state, the rod 13 is fixed to the positive electrode terminal 4. In addition, it is preferable that inserting operation is made easier resourcefully by taper grinding of the hole created in the metal terminal and the rod 13. The co-rotation of the rod 13 is prevented when the rod 13 is attached to and removed from a nut, by forming the hole created in the metal terminal and the stud section of the rod 13 into polygonal-columnar shapes such as a square-columnar shape and a hexagonal-columnar shape, or shapes such as a star-shape, not a cylindrical shape. Furthermore, it is also preferable that the hole and the rod are fixed together with adhesives such as isocyanate-based adhesive or epoxy adhesive (for space resin, Loctite KIT0 151 is preferable). It is to be noted that it is possible to employ the negative electrode terminal which has the same structure as the structure in these examples of the positive electrode terminal.

The positive electrode terminal 4 shown in FIG. 3 is also inserted into the inner cylinder of the ceramics insulation cylinder 6 from the lower part. This positive electrode terminal 4 is a cylindrical pin composed of aluminum or aluminum alloy which does not dissolve in a nonaqueous electrolyte solution at a positive electrode potential (particularly at a positive electrode potential of a lithium ion battery). A hole is formed at the center of the upper portion of the positive electrode terminal 4. The rod 13 made of SUS304 stainless steel is pressed into and fixed to the hole. This rod 13 corresponds to the “member composed of a material whose mechanical strength is higher than the metal terminal” in the present invention. Regarding this rod 13, the portion thereof which protrudes outside the hole created in the positive electrode terminal 4 corresponds to the “projecting portion” in the present invention. A male screw part is created in this projecting portion. The lower end portion of the positive electrode terminal 4, as shown in FIG. 9, is welded to the current collector connected to the positive electrode of the power generating element 1. The material of the ceramics insulation cylinder 6 is 99% alumina which is not prone to corrosion by nonaqueous electrolyte solution characteristically. The insulation cylinder 6 and the positive electrode terminal 4 are brazed together with the aluminum brazing 8, and a metallized layer is adhered to the surface to be brazed with the aluminum brazing 8. Also, the engagement part between the terminal support plate 7 and the insulation cylinder 6 is brazed with the aluminum brazing 9.

It is to be noted that it is possible to employ the structure similar to the structure in FIG. 3 in which the rod is pressed into and fixed to the hole of the negative electrode terminal. In this case, the insulation cylinder and the negative electrode terminal are brazed together with copper alloy-based metal brazing.

The insulation cylinder 6 to which the positive electrode terminal 4 and the negative electrode terminal 5 are sealed and fixed, similarly to the conventional example shown in FIG. 9, are inserted into the open holes of the terminal support plates 7 respectively. The engagement part between the open hole and the insulation cylinder 6 is sealed and fixed by brazing with the aluminum brazing 9. Also, the terminal support plates 7 and 7 to which the positive electrode terminal 4 and the negative electrode terminal 5 are thus sealed and fixed respectively, similarly to the conventional example, are respectively fitted into the open holes created at both ends of lid plate 3, and sealed and fixed by welding. And after the power generating element 1 is accommodated inside the metal container 2, the inside of the battery case is closed by fitting this lid plate 3 into the upper end opening part of the metal container 2 and welding.

In any battery provided with the structure in FIGS. 1 to 3, an outer lead for connecting the battery to an electronic device is employed. The outer lead is preferably provided with a through hole. The through hole is drilled through the bolt 12 or the rod 13, and a presser component in which the female screw is created is then fitted into the male screw part created in the projecting portion of the bolt 12 or the rod 13. The outer lead is pressed against the upper end of the metal terminal by tightening the female screw of the presser component. Therefore, the outer lead and the metal terminal are brought into contact with each other in a large area. Since the electric resistance between the outer lead and the metal terminal decreases in the result, large electric current can pass therebetween. Furthermore, compared with the case as described in 2000-138055A of the Japanese published patent application, in which a helical insert or a sleeve is employed for the hole of the metal terminal, the diameter of the terminal can be smaller by the size of the helical insert or the sleeve. Therefore, the weight of the terminal becomes lighter with the result that the battery becomes lighter and the weight energy density of the battery is increased. Also, since the terminal becomes smaller in the present invention, it becomes possible to design a compact battery. Compared with the case as described in 2000-138055A of the Japanese published patent application, in which a projecting portion sleeve of the metal terminal is employed, the contact area between the metal terminal and the outer lead becomes larger by the size of the sleeve in the present invention. Therefore, since the electric resistance value between the terminal and the outer lead can be decreased, large electric current can pass through.

The outer lead of the present invention may be a lead wire to which a ring-shaped conductive connecting component is connected. In this case, from the metal terminal, the conductive connecting component, the lead wire and the electronic device are electrically connected in order by the connection of the lead wire to the conductive connecting component. Furthermore, in the outer lead of the present invention, the conductive connecting component connected to the lead wire does not necessarily require to be ring-shaped. For example, the outer lead may also be a metal connecting component whose connection part to the metal terminal is U-shaped.

It is to be noted that the abovementioned embodiment relates to the case in which SUS304 stainless steel is employed for the material of the bolt 12 and the rod 13, but the material is not limited to the SUS304 stainless steel, and may preferably be iron to which anticorrosive treatment is applied so that the iron is not prone to corrosion. Additionally, any one material chosen from alloy containing chrome and iron, nickel and nickel alloy is also preferable. In each material, it is preferable for the relevant material to have sufficient mechanical strength to support and fix the outer lead plate. Examples of the metal materials of the bolt 12 and the rod 13 include nickel-plated iron, stainless steels such as SUS430 and SUS316, nickel and nickel alloy, besides SUS304 stainless steel.

Furthermore, for the stud section of the terminal female screw part of this bolt 12, it is preferable to employ the B 1173 stud bolt standard of the Japan Industrial Standard (JIS). By employing grade 6H or 2nd for the female screw part and combining with the bolt, the female screw part and the bolt become what is termed in a trasition-fit and the looseness of the bolt relative to the female screw is minimized. As a result, since the bolt perpendicularity relative to the upper surface of the terminal can be precisely maintained, the outer lead plate is easily fixed.

As a concrete example of the present invention, materials for positive electrode terminal, materials for the negative electrode terminal, and mechanical strength of the materials of the members provided in the positive electrode terminal and the negative electrode terminal are listed in Table 1. It is to be noted that “mechanical strength” shall mean tensile strength (breaking strength) in the present invention. The source of the tensile strength data listed in Table 1 is Jitsuyou Kinzoku Binran (Metal Handbook for Practical Use) edited by the Jitsuyou Kinzoku Binran Editing Committee, published by the Nikkan Kogyo Shimbun Ltd. (October, 1962).

TABLE 1

| | | Tensile strength, |
|---|---|---|
| Metal materials | Composition, wt % in parentheses | kg/mm² |
| Aluminum | — | 9-23 |
| Aluminum alloy | Cu (7-9) | 12-18 |
| | Cu (2-5), Zn (8-12) | 12-18 |
| | Cu (4), Ni (2), Mg (1.5) | 23-27 |
| Copper | Processing degree 25.5 or below | 20.3-29.7 |
| Copper alloy | Zn (30.2-47.03) | 10.0-17.7 |
| Iron | Hard steel | 58-70 |
| | Mild steel | 38-48 |
| Iron chrome alloy | Cr (1.1-1.5), Ni (4.25-4.75) | 110-115 |
| SUS304 | Cr (0.3-0.7), Ni (1.25-1.75) | 65-75 |
| | Cr (18), Ni (8) | 55-70 |
| Nickel | — | 33-42 |
| Nickel alloy | Cu (30-34), Al (3.45) | 56 |

As is clear from Table 1, according to the structure of the present invention, the positive electrode terminal 4 composed of aluminum or aluminum alloy and the negative electrode terminal 5 composed of copper or copper alloy are provided with a member composed of a material whose mechanical strength is higher than the material composing these terminals. Therefore, even when mechanical stress is applied on the terminal during assembly process or use of the battery, destruction of the terminal part can be reliably prevented.

Furthermore, the negative electrode terminal 5 is composed of copper or copper alloy which is not prone to electrochemical corrosion at a negative electrode potential (particularly at a negative electrode potential of a lithium ion battery). Therefore, even when the negative electrode terminal 5 makes contact with electrolyte solution in the battery, corrosion is difficult to progress. As a result, production of a long-lived nonaqueous electrolyte battery becomes possible. Also, the positive electrode terminal 4 is composed of aluminum or aluminum alloy which is not prone to electrochemical corrosion at a positive electrode potential (particularly at a positive electrode potential of a lithium ion battery). Therefore, even when the positive electrode terminal 5 makes contact with electrolyte solution in the battery, corrosion is difficult to progress. As a result, production of a long-lived nonaqueous electrolyte battery becomes possible.

When the bolt is inserted in the female screw, a resin screw lock agent is preferably employed in combination. For the material of the screw lock agent, isocyanate-based adhesive or epoxy adhesive (for space resin, Loctite KIT0151 is preferable) is employed, and the bolt 12 can be reliably fixed to the positive electrode terminal 4 and the negative electrode terminal 5 by coating the male screw part of the bolt with the screw lock agent and then inserting the bolt into the female screw.

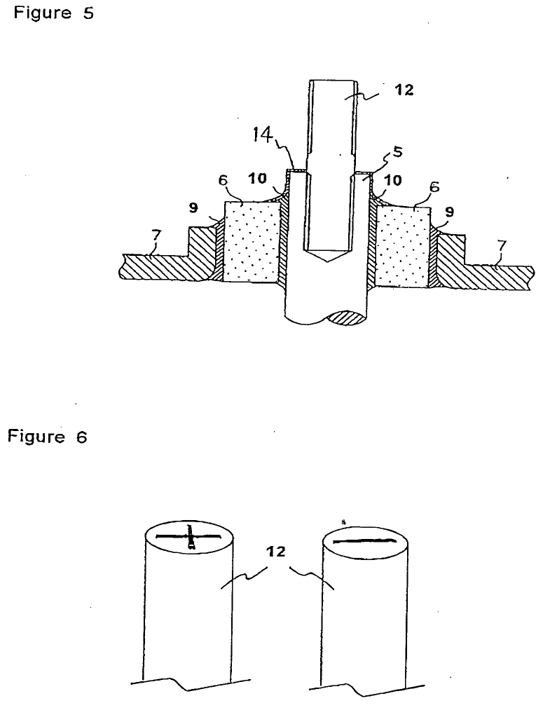

FIG. 4 and FIG. 5 show a second embodiment of the present invention. FIG. 4 is a partially enlarged longitudinal cross-sectional view showing the structure of the positive electrode terminal of the nonaqueous electrolyte secondary battery. FIG. 5 is a partially enlarged longitudinal cross-sectional view showing the structure of the negative electrode terminal of the nonaqueous electrolyte secondary battery. It is to be noted that the structural member which has a similar function in the first embodiment shown in FIGS. 1 to 3 has the same reference number, and its detailed description is omitted here. In both of FIG. 4 and FIG. 5, the upper sides of the terminal support plates 7 and 7 correspond to the outside of the battery case, and the bottom sides of the terminal support plates 7 and 7 correspond to the inside of the battery case.

As shown in FIG. 4, the surface of the positive electrode terminal 4 outside the battery is coated by nickel-plating 14. As described above, the positive electrode terminal 4 is composed of aluminum, aluminum alloy or the like. Therefore, when a bolt 12 made of SUS304 stainless steel is embedded into the positive electrode terminal 4, potential difference occurs between the positive electrode terminal 4 and the bolt 12. As a result, the problem occurs that corrosion of the terminal progresses, caused by moisture and salt in the air. However, the potential difference between the embedded bolt 12 and the positive electrode terminal 4 decreases by nickel-plating the surface of the positive electrode terminal 4 outside the battery. Therefore, progress of the corrosion is prevented.

As shown in FIG. 5, the surface of the negative electrode terminal 5 outside the battery is coated by the nickel-plating 14. As described above, the negative electrode terminal 5 is composed of copper or copper alloy. Therefore, when the bolt 12 made of SUS304 stainless steel is embedded into the negative electrode terminal 5, potential difference occurs between the negative electrode terminal 5 and the bolt 12. Therefore, the problem occurs that corrosion of the negative electrode terminal progresses, caused by moisture and salt in the air. However, the potential difference between the negative electrode terminal 5 and the embedded bolt 12 decreases by nickel-plating the surface of the negative electrode terminal 5 outside the battery. As a result, progress of the corrosion is prevented.

Thus, corrosion becomes difficult to progress even when the metal terminal makes contact with moisture and salt, by coating the surfaces of the positive electrode terminal 4 and the negative electrode terminal 5 outside the battery with nickel. Therefore, a long-lived nonaqueous electrolyte battery can be obtained.

It is to be noted that the abovementioned embodiment relates to the case in which SUS304 stainless steel is employed for the material of the bolt 12, but a similar effect can be obtained using stainless steels such as SUS430 and SUS316, nickel and nickel alloy or the like, besides SUS304 stainless steel. Also, although the above description relates to the case in which the surface of the terminal is nickel-plated, a similar effect can be obtained by gold plating or silver plating, besides nickel plating. Furthermore, the surface of the terminal may be coated by applying conductive paste containing nickel, gold, or silver.

In the battery of the present invention, polarity of the positive electrode or/and negative electrode can be displayed on the upper end surface of the member provided in the metal terminal. FIGS. 6 to 8 show examples of polarity display. FIGS. 6 to 8 are partially enlarged perspective views showing the upper end portion of a member 12 embedded into the positive and negative electrode terminals of the nonaqueous electrolyte secondary battery. It is to be noted that the description here relates to the case in which the bolt made of SUS304 stainless steel as the member 12.

As shown in FIG. 6, the characters of plus (+) and minus (−) is printed on the upper end surface of the bolt 12 in indelible ink as polarity display of the terminal. Since polarity is thus displayed on the upper end surface of the bolt, even in the situation in which the upper surface of the battery is covered with a printed-circuit board or the like and only a stud bolt protrudes from the hole of the printed-circuit board during assembly process of the battery, the assembly operation can be made without reversing the polarities of the terminals. Therefore, accidents such as short circuit caused by faulty operation can be reliably prevented.

It is to be noted that in the abovementioned embodiment describes the case in which the characters of plus (+) and minus (−) are printed in indelible ink at the upper end of the bolt 12, but the character display by laser marking, adhesive tape or the like is possible in addition. Besides the abovementioned methods, identification by color (for example, red for positive electrode and black for negative electrode) is also preferable. In this case, coating material or adhesive tape can be employed.

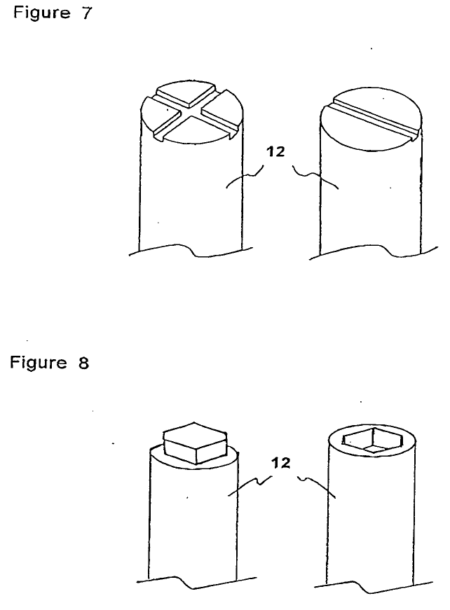

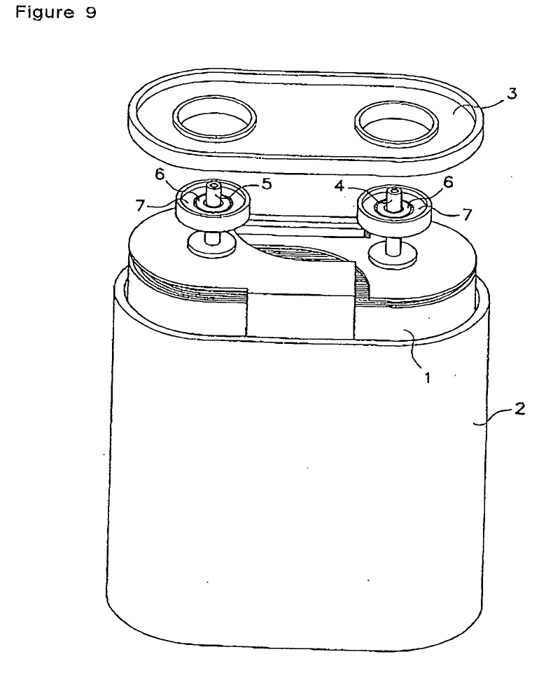

Furthermore, as shown in FIG. 7 and FIG. 8, it is also preferable that a recess portion or a projecting portion is formed at the upper end of the bolt 12. In this case, since the nut can be tightened fixing the recess portion or projecting portion of the upper end portion of the bolt 12 when the outer lead is fixed to the terminal with a nut, destruction of the terminal caused by the co-rotation of the stud bolt can be reliably prevented.

It is to be noted that although in the abovementioned embodiment the description relates to the case in which a ceramics-hermetic seal terminal which employs 99% alumina as the material of the insulation cylinder 6 is employed, alumina of a lower degree of purity of 92% or the like may be employed and the present invention can also be employed for the terminal which employs resin packing or an O-ring other than the terminal insulation and fixation method by the combination of ceramics and metal brazing.

Also, although the abovementioned embodiment shows the case in which the battery case is made up of the metal container 2, the lid plate 3, and the terminal support plate 7, the structure of this battery case is arbitrary, and it is also possible that the insulation cylinder 6 is directly brazed with the open hole of the lid plate 3 without using the terminal support plate 7, and that the positive electrode terminal 4 or the negative electrode terminal 5 is arranged on the side of the metal container 2. Furthermore, setting the battery case itself to the terminal of either polarity, only the positive electrode terminal 4 or negative electrode terminal 5 of the other polarity is fixed to the open hole of this battery case through the insulation cylinder 6. Additionally, the battery case which has the structure other than the combination of the metal container 2 and the lid plate 3 is similarly applicable.

Also, although the abovementioned embodiment describes the nonaqueous electrolyte secondary battery, the embodiment is not limited to secondary batteries, is similarly applicable to a nonaqueous electrolyte battery of primary batteries, and a polymer battery is also included in the nonaqueous electrolyte batteries.

This application is based on the Japanese Patent Application No.2003-344981 filed on Oct. 2, 2003. The entire disclosure of the specification is incorporated herein by reference.

1. A battery comprising:
a battery case;
a metal terminal fixed to said battery case;
a hole created in said metal terminal, having an opening part outside of said battery case;
a member fitted into said hole, composed of a material whose mechanical strength is higher than that of said metal terminal, wherein said member comprises a projecting portion which protrudes from said hole; and
a male screw part created in said projecting portion.

2. The battery as set forth in claim 1, wherein
said metal terminal is a negative electrode terminal,
a material of said metal terminal is one of copper and copper alloy, and
said member is composed of one material chosen from iron, alloy containing chrome and iron, nickel and nickel alloy.

3. The battery as set forth in claim 1, wherein
said metal terminal is a positive electrode terminal,
a material of said metal terminal is one of aluminum and aluminum alloy, and
said member is composed of one material chosen from iron, alloy containing chrome and iron, nickel and nickel alloy.

4. The battery as set forth in claim 1, wherein
a material of said metal terminal is one of copper, copper alloy, aluminum and aluminum alloy, and
a surface of said metal terminal is coated by one of nickel plating, gold plating and silver plating.

5. The battery as set forth in claim 1,
wherein said member is combined with said hole with a screw.

6. The battery as set forth in claim 1, wherein
a presser component in which a female screw is created is fitted into said male screw part, and
an outer lead is pressed against said metal terminal by said presser component.

7. The battery as set forth in claim 1,
wherein said metal terminal is fixed to said battery case through an insulator.

8. The battery as set forth in claim 1,
wherein said battery is a nonaqueous electrolyte battery.

9. The battery as set forth in claim 1,
wherein said battery is a lithium ion battery.

10. The battery as set forth in claim 2,
wherein said battery is a lithium ion battery.

11. The battery as set forth in claim 3,
wherein said battery is a lithium ion battery.

12. The battery as set forth in claim 4,
wherein said battery is a lithium ion battery.

13. The battery as set forth in claim 1,
wherein said battery has rated capacity more than 5 Ah.
